(19) United States
(12) Patent Application Publication
(10) Pub. No.: US 2023/0244931 A1
(43) Pub. Date: Aug. 3, 2023

(54) CONTROLLED TARGET DEVICE SELECTION APPARATUS, CONTROLLED TARGET DEVICE SELECTION METHOD AND PROGRAM

(71) Applicant: Nippon Telegraph and Telephone Corporation, Tokyo (JP)

(72) Inventors: Hikotoshi NAKAZATO, Musashino-shi, Tokyo (JP); Kenji ABE, Musashino-shi, Tokyo (JP)

(21) Appl. No.: 18/024,313

(22) PCT Filed: Sep. 9, 2020
(86) PCT No.: PCT/JP2020/034153

§ 371 Date: Mar. 2, 2023

(51) Int. Cl. G06N 3/08

(52) U.S. Cl. CPC G06N 3/08

(57) ABSTRACT

A control target device selection apparatus (1) includes: a situation classification unit (122) for extracting an external factor affecting a reward as a component and defining a situation for controlling a control target device (5) as a classification for each divided range; a learning data management unit (123) for storing learning data for each device control factor pattern in a learning data DB; a learning model management unit (124) for generating a learning model for each classification, a non-involved device specification unit (1271) for determining non-involved devices and a range of classification of non-involved devices; and, with respect to the range of the non-involved classification, a device control unit (130) for transmitting a device control value to each control target device (5) excluding the non-involved device.

### TECHNICAL FIELD

The present invention relates to a control target device selection apparatus, a control target device selection method, and a program that select a control target device to be controlled using a control value generated using reinforcement learning.

### BACKGROUND ART

For detecting abnormal states in a system, a technology for classifying abnormal states by DNN (Deep Neural Network) using only the training data of normal states has been published (see, for example, PTL 1).

According to the technique of PTL 1, when the tendency of the normal state changes in time series, a learning model is reconstructed using only the learning data for a certain period of time from the most recent period. Further, the normal outliers can be used to reconstruct the learning model by limiting to specific types of data from the most recent fixed period of data, so as to correspond to the tendency change of the “normal outliers” such as a temporary high load.

### CITATION LIST

### Patent Literature

[PTL 1] WO 2019/138655

### SUMMARY OF INVENTION

### Technical Problem

On the other hand, a reward (score) can vary significantly with changes in external conditions measured as the environment (hereafter referred to as “disturbance”). Although the technique described in PTL 1 reconfigures the learning model by assuming a time-series change of the system state value itself, disturbance caused by a factor affecting the fluctuation of the system state value is not considered. In addition, it is necessary to manually specify a factor (“external factor” which will be described later), which gives a variation to the reward (score) in the conventional reinforcement learning, and it is also necessary to manually define the range of the specific factor as “situation” (Situation) for each class.

As for this problem, by automatically extracting a disturbance component factor (external factor) which gives variation to a reward (score) in reinforcement learning, automatically defining a “situation” (Situation) on the basis of the disturbance component factor, and updating a learning model, a proper control value of the device to be controlled (control target device) is generated, and the device can be controlled.

By the way, in a system for performing inter-device cooperation control in an individual environment utilizing reinforcement learning, control is gradually optimized so as to satisfy a predetermined reward (target reward) while each control target device is cooperating in the individual environment. In this case, there is a device which is not involved in the achievement of the reward, that is, a device which does not change the state of the achievement of the reward even if the device does not operate, by investing such devices in other tasks, and making the device non-operation, the operation efficiency of the device can be improved. At the devices that is not involved in the reward achievement (may be referred to as “non-involved device” hereinafter), there are two kinds of devices: (1) devices that are not involved in the achievement of the reward regardless of the situation of the environment, and (2) devices that are not involved in the achievement of the reward in the specific situation of the environment.

A target vehicle tracking system as shown in FIG. 1 will be described as an example of a system for performing inter-device cooperative control in an individual environment utilizing reinforcement learning. In this system, a vehicle to be moved is tracked by a swing camera 5a which is a device to be controlled on a certain course (from a start point to an end point of the course). The control value of each swing camera 5a for tracking the vehicle is generated by a learning model which is reinforced and learned, based on information of “situation” (Situation) obtained from a fixed camera 3a (here “a speed of the vehicle” which is an external factor to be described later).

Here, the reward (score) set in the reinforcement learning is the sum of the time when the target vehicle can capture the vehicle by any one of the swing cameras 5a among the time required for the target vehicle to pass the course of the tracking section. That is, the longer the time when any swing camera 5a captures the target vehicle through the whole course of the tracking section, the higher the score is obtained.

In this environment, the swing camera 5a₁ of the swing cameras 5a being the control target device is positioned in the vicinity of the course, but the course is not included in the photographing range, the device is a device which is not involved in the achievement of the reward regardless of “situation” (Situation) (“a speed of the vehicle”).

Also, the swing camera 5a₂ becomes a device which is not involved in the achievement of the reward in the “situation” (Situation) in which the speed of the vehicle is 50 km or more because the swing cameras 5a positioned on the right and left sides of the swing camera 5a₂ can capture the vehicle at the same time in the “situation” (Situation) in which the speed of the vehicle is 50 km or more.

Operating continuously such a device as described above which is not involved in the achievement of the reward leads to a reduction in the operation efficiency of the device.

The present invention is accomplished taking such point into consideration, the present invention is intended to improve device operation efficiency by specifying a device that is not involved in reward achievement in reinforcement learning and a range of “situation” (Situation) in which the device is not involved, and selecting a device to be controlled other than the device that is not involved.

### Solution to Problem

A control device selection apparatus according to the present invention is a control target device selection apparatus for selecting a control target device, and includes:
a situation classification unit which, with respect to external factors indicated by the data acquired from each IoT device, extracts an external factor that affects a reward as a component, by calculating an impurity of each external factor, divides the extracted value of the external factor into a predetermined range width, and defines a situation for controlling the control target device as a classification for each divided range;
a control value generation unit which, with respect to external factors indicated by the data acquired from each IoT device, generates a device control value of a plurality of control target device for each of the classification;
a score calculation unit which calculates a score indicating a reward obtained from a control result of each of the control target device;
a learning data management unit which stores in a learning data DB, each learning data indicated by the device control value and the score, for each device control factor pattern indicating a device control value included in the same classification;
a learning model management unit which generates a learning model for each of the classifications by performing reinforcement learning so as to satisfy a predetermined reward by using the learning data;
a non-involved device specification unit which, with respect to the device control factor pattern of each of the classifications,
changes only a control value of a specific control target device,
when a score that is a control result after change, falls within a predetermined range among ranges obtained by dividing an upper limit value and a lower limit value of the score into predetermined range widths,
executes a non-involved device candidate specification processing for specifying the specific control target device as a non-involved device candidate and specifying a range of non-involved classification in the non-involved device candidate,
executes the non-involved device candidate specification processing in each of the control target devices,
selects a device control value from the device control factor patterns for each non-involved classification,
executes control of the control target device excluding the specified non-involved device candidate,
and when a prescribed reward is satisfied, determines the non-involved device candidate as a non-involved device and the range of the non-involved classification;
and a device control unit which, with respect to the range of the non-involved classification, transmits the device control value to each control target device excluding the non-involved device.

### Advantageous Effects of Invention

According to the present invention, a device that is not involved in reward achievement in reinforcement learning and a range of “situation” (Situation) in which the device is not involved is specified, and control target devices excluding non-involved devices are selected, and device operation efficiency can be improved.

### BRIEF DESCRIPTION OF DRAWINGS

FIG. 1 is a diagram for explaining a target vehicle tracking system as an example according to the present embodiment.

FIG. 2 is a diagram for explaining “situation” (Situation) and “device control factor” as factors that affect the reward (score) variation.

FIG. 3 is a block diagram showing a configuration of the control target device selection apparatus according to the present embodiment.

FIG. 4 is a diagram for explaining non-involved device specification processing according to the present embodiment.

FIG. 5 is a flowchart showing the flow of non-involved device specification processing that is executed by the control target device selection apparatus according to the present embodiment.

FIG. 6 is a flowchart showing the flow of non-involved device specification processing that is executed by the control target device selection apparatus according to the present embodiment.

FIG. 7 is a hardware configuration diagram showing an example of a computer that realizes functions of the control target device selection apparatus according to the present embodiment.

### DESCRIPTION OF EMBODIMENTS

An embodiment for carrying out the present invention (hereinafter, referred to as “the present embodiment”) will be described below. First, in the inter-device cooperative control system in the individual environment utilizing the reinforcement learning, a factor which affects a reward (score) variation in performing the reinforcement learning, which is a prerequisite in the present invention, is defined. In the present embodiment, two of “situation” (Situation) and “device control factor” are defined as factors that affect the reward (score) variation.

The “situation” (Situation) is further classified into two of “external factor” and “location characteristics”.

The “external factors” refers to factors that are known to have the potential to affect the variation of rewards and whose values can be measured by instruments or other means. There are some factors affecting the variation of the reward and those not affecting the variation of the reward, and in the case of defining the “situation” (Situation), an external factor affecting the influence is handled.

The “location characteristic” is a factor that affects unknown (unmeasurable) reward variation other than the external factor. A specific location characteristic pattern exists for each specific environment (location). However, when determining the optimum device control value by the reinforcement learning under the individual environment, it is a factor which is hidden and not considered.

The “device control factor” is information indicating a control value in each device (for example, a List type) of a device group to be controlled (“control target device group” to be described later). The control value for each device (referred to as “device control value”) may be regarded as the same category for each predetermined range width to constitute a device control factor.

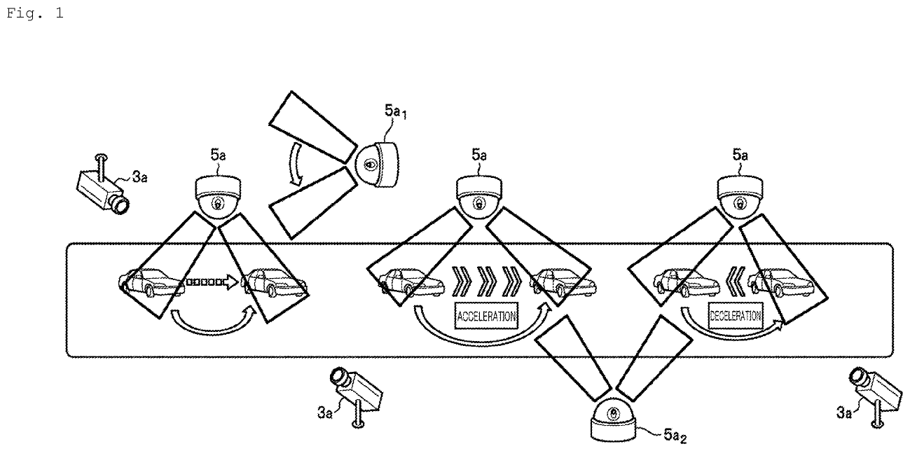

In the example of the target vehicle tracking system shown in FIG. 1, the device to be controlled is a swing camera 5a, and the “device control factor” (device control value) calculated by the reinforcement learning are the direction of rotation of the swing camera 5a, the designed angle (an angle designated when starting rotation for tracking of the target vehicle), and the rotation start time (a time from setting to the designated angle of until starting the rotation thereafter) or the like.

The “external factor” is, for example, the speed of the vehicle. Then, in a case when the external factor (component) of the “situation” (Situation) is the speed of the vehicle, the “situation” (Situation) is classified for each predetermined range width. For example, the speed is set 0 to 5 km as Situation “A”, the speed is set 16 to 30 km as Situation “B”, and the speed is set 31 to 45 km as Situation “C”. In the example shown in FIG. 1, the speed of the vehicle is measured by a fixed camera 3a, the corresponding “situation” (Situation) is specified by using information on the speed, and a device control value (here, a rotation direction, a designated angle, a rotation start time, etc.) corresponding to the “situation” (Situation) (for example, when the speed of the vehicle is 20 km, the speed 16 to 30 km of the Situation “B”) is set, and each camera device (swing camera 5a) is controlled. Then, in the control result (here, the ratio of the time supplemented by each camera device among the time when the vehicle passes the course) is calculated as a reward (score).

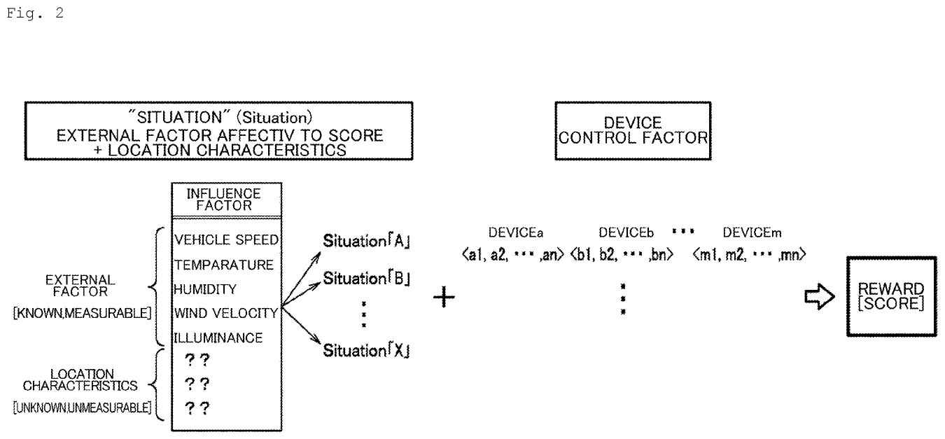

In the example described with reference to FIG. 1, the external factor is described only by the speed of the vehicle. However, actually, factors affecting the reward variation are not only the speed of the vehicle, there are other known measurable factors as shown in FIG. 2, for example, such as temperature, humidity, wind velocity for detecting the generation of fog on a road, illumination which affects night photographing, and the like. Also, as unknown and unmeasured location characteristics, for example, for reducing the speed of the traveling vehicle, the installation of “hump” (bump, knob) on roads, installation of narrowing barriers to narrow the width of the road, the influence of growth of trees on driving around roads is given.

A device control factor of each device is set for each “situation” (Situation) determined by an external factor affecting these score variations and location characteristics, and a reward (score) is calculated.

The present invention is not limited to the target vehicle tracking system shown in FIGS. 1 and 2, but may be any system for performing inter-device cooperative control in an individual environment utilizing reinforcement learning. For example, the present invention can be applied to various systems, such as a cooling system of a data center, a robot automatic transport system in a factory, and an irrigation water adjustment system in a farmer.

In a cooling system of a data center, as external factors, information such as temperature around each server, outside air temperature, power consumption of the server, the operation efficiency of the server is acquired, and a target reward is that the total power consumption is equal to or less than a predetermined value and the temperature is lowered by X degrees or more within a time t in the area, or the like. At this time, the control target device is an air conditioner, and the device control factor (device control value) are air volume, target temperature, wind direction and the like. In this case, the air conditioner which is not involved in the achievement of the reward is specified, and the other air conditioners except the specified air conditioner are set as the control target device.

In a robot automatic transportation system in a factory, information such as camera images of each robot is acquired as an external factor, and a target reward is made to transport all cargoes to a line accurately in a shorter time. The control target device at this time is a transportation robot, and the device control factor (device control value) are the speed of the robot, the motor rotation speed, brake strength and the like. In this case, the robot for transportation which is not involved in the achievement of the reward is specified, and the other robot for transportation excluding the specified robot for transportation is set as the control target device.

In an irrigation water amount adjustment system in a farmhouse, information on temperature, humidity, sunlight, soil moisture, soil quality, rainfall, and plant growth are acquired from sensors set up on farmland as external factors, and the target reward is that the soil moisture content is above a specified value and the final harvest is above a specified value. At this time, the control target device is a compost robot, and the device control factor (device control value) is water amount, compost amount or the like. In this case, a compost robot which is not involved in the achievement of the reward is specified, and the other compost robot except the specified compost robot is set as the control target robot.

As described above, the present invention is applicable to a system for performing inter-device cooperative control in an individual environment utilizing reinforcement learning, a target vehicle tracking system will be described as an example.

A control target device selection apparatus 1 according to the present embodiment specifies a device that is not involved in reward achievement in reinforcement learning, and specifies a range of “situation” (Situation) in which the specified device is not involved. Then, the control target device selection apparatus 1 selects the control target device except for the non-involved device in the specified “situation” (Situation) and executes device control. Thus, the operation efficiency of the device can be improved by turning the non-involved device to another task or making it non-active.

Further, the control target device selection apparatus 1 updates appropriately non-involved devices and a range of “situation” (Situation), according to a review of the definition of “situation” (Situation), and to the change of the location characteristic.

Hereinafter, a specific configuration of the control target device selection apparatus 1 will be described.

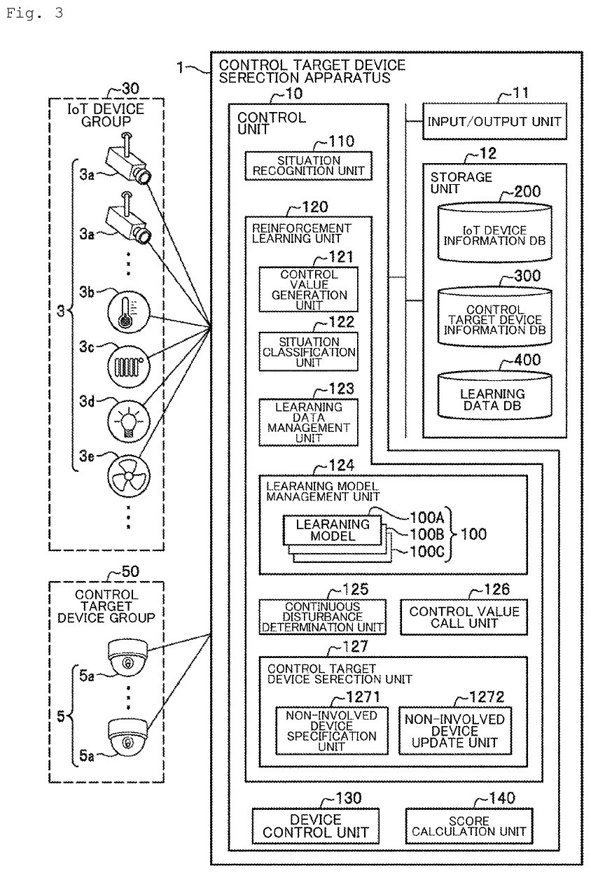

FIG. 3 is a block diagram illustrating the configuration of the control target device selection apparatus 1 according to the present embodiment.

The control target device selection apparatus 1 is communication connected with IoT devices 3 such as a camera device (fixed camera 3a), various sensor devices (for example, a temperature sensor 3b, a humidity sensor 3c, an illumination sensor 3d, an anemometer 3e, etc.). Then, the control target device selection apparatus 1 generates a device control value by reinforcement learning so that a reward (score) becomes equal to or more than a predetermined value and controls the control target device 5 communication connected with. The control target device 5 is a swing camera 5a in an example of a target vehicle tracking system. At this time, the control target device selection apparatus 1 selects control target devices 5 excluding a non-involved device (swing camera 5a) and performs control by a device control value.

The control target device selection apparatus 1 includes a control unit 10, an input/output unit 11, and a storage unit 12.

The input/output unit 11 inputs and outputs information between each IoT device 3 of the IoT device group 30 and each control target device 5 of the control target device group 50. The input/output unit 11 is composed of a communication interface through which information is transmitted and received via a communication line, and an input/output interface through which information is input to and output from an input device such as a keyboard and an output device such as a monitor (not illustrated).

The storage unit 12 is composed of a hard disk, a flash memory, a RAM (Random Access Memory), etc.

The storage unit 12 stores IoT device information DB 200, control target device information DB 300, and learning data DB 400 as shown in FIG. 3. Further, the storage unit 12 temporarily stores a program for implementing each control unit 10 of the control unit 10 and information necessary for processing of the control unit.

In the IoT device information DB 200, information on the type of the IoT device and information on the installation position are stored in association with the identification information of each IoT device 3.

In the IoT device information DB 200, for each type of the IoT device 3, an upper limit value and a lower limit value of an external factor which is information that can be acquired from the IoT device 3, and a class which is a divided range obtained by dividing a range indicated by the upper limit value and the lower limit value into N are stored in advance. This divided range is is tentatively set during the initial learning phase (see below for details) to obtain training data.

In a control target device information DB 300, information on a type of the control target device 5 and information on an arrangement position are stored in association with identification information on each control target device 5. The control target device information DB 300 manages a set of control target device groups 50 related to the calculation of the reward (score) as spots. A plurality of spots may be stored in the control target device information DB 300.

In a learning data DB 400, a device control value for each control target device 5 generated by the control target device selection apparatus 1 and a reward (score) when the control target device 5 is controlled by the device control value are stored as learning data. In the learning data, the device control value of each device 5 to be controlled is stored as a device control factor pattern for each class of “situation” (Situation) set by the control target device selection apparatus 1.

The control unit 10 controls the whole processing executed by the control target device selection apparatus 1, and includes a situation recognition unit 110, a reinforcement learning unit 120, a device control unit 130, and a score calculation unit 140.

A situation recognition unit 110 acquires data from each IoT device 3 of the IoT device group 30. In the data, measurement values of external factors (such as speed, temperature, humidity, and the like) of a vehicle, measured by each IoT device 3, the identification information of each IoT device 3. Then, the situation recognition unit 110 determines a range for each external factor on the basis of the value of each data, and determines “situation” (Situation).

Specifically, in an initial learning stage, the situation recognition unit 110 specifies, on the basis of a value of data acquired from each IoT device 3, a class in the divided range of the external factor stored in the IoT device information DB 200. Note that, the “initial learning stage” refers to a stage before defining of “situation” (Situation) (extraction and classification of component) performed by a reinforcement learning unit 120 (situation classification unit 122) which will be described later. When simply describing “learning stage”, “situation” (Situation) is defined and reinforcement learning with learning data is being performed.

The situation recognition unit 110, in a learning stage and, in an operation stage after a prescribed reward (score) is satisfied, determines on the basis of a value of data acquired from each IoT device 3, in the “situation” (Situation) defined by the reinforcement learning unit 120 (situation classification unit 122), which of the classified “situation” (“situation” (1Situation) to be described below) the data belongs.

A reinforcement learning unit 120 extracts an external factor having a large influence on the increase/decrease of the reward (score) as an influence factor (component) of the “situation” (Situation). Then, the reinforcement learning unit 120 classifies each external factor of the “situation” (Situation) for each predetermined range width, and generates a device control value of each control target device 5.

Then, the reinforcement learning unit 120 specifies a device which is not involved in the achievement of the reward in the reinforcement learning when the learning stage is finished by reaching a predetermined reward (target reward), and specifies a range of “situation” (Situation) in which the specified device is not involved. Then, the reinforcement learning unit 120 selects a control target device except for a device not involved in the specified “situation” (Situation), and executes device control as an operation stage.

The reinforcement learning unit 120 updates an external factor which is a component of the “situation” (Situation), for each predetermined period, and updates a learning model for each “situation” (Situation) and restores learning data again. Further, the reinforcement learning unit 120 regards continuous disturbance occurrence in which a reward (score) largely fluctuates compared to the past continuously for a predetermined period as a change in location characteristics, stores learning data of new location characteristics, and regenerates a learning model for each “situation” (Situation). As described above, when the external factor and range of the “situation” (Situation) are updated, or when the location characteristics are changed, the reinforcement learning unit 120 specifies non-involved device again and updates the range of the non-involved “situation” (Situation).

As shown in FIG. 3, the reinforcement learning unit 120 includes a control value generation unit 121, a situation classification unit 122, a learning data management unit 123, a learning model management unit 124, a continuous disturbance determination unit 125, a control value call unit 126, and a control target device selection unit 127.

In an initial learning stage where learning data is small, a control value generation unit 121 generates a control value for each divided range of each external factor specified by the situation recognition unit 110, and generates a device control value associated with a measurement value of a external factor (for example speed of the vehicle, temperature, humidity, etc.). At this time, the control value generation unit 121 generates control values of the control target devices 5, for example, at random.

In the initial learning stage, the device control value generated by the control value generation unit 121 is transmitted to each control target device 5 via the device control unit 130, and a score calculation unit 140 calculates a reward (score) as the result. Thus, a learning data management unit 123 stores learning data in a learning data DB 400 in a storage unit 12.

Under the individual environment (specific location characteristic), with a pattern of the same device control factor (hereinafter referred to as the “device control factor pattern”), a situation classification unit 122 extracts an external factor having a large influence on the reward (score) by changing the specific external factor. Then, a situation classification unit 122 extracts external factors appearing in common in the plurality of device control factor patterns as components of “situation” Situation) and classifies each component by a predetermined range width.

For example, the situation classification unit 122 extracts an external factor having a large influence on the reward (score) as a component of the “situation” (Situation) in the following manner.

The situation classification unit 122 specifies one external factor from the plurality of external factors. Then, the situation classification unit 122 fixes the external factors other than the specified external factor and the device control factor pattern, and then extracts learning data in which the value of only the specified external factor is changed from the learning data DB 400. Here, “change” in the value of the external factor indicates that the external factor is shifted to a different range among divided ranges obtained by dividing the range between the upper limit value and the lower limit value of the external factor into N parts. The situation classification unit 122 extracts a reward (score) of learning data in which each of the values of the specified external factors is changed, in the same device control factor pattern.

Then, the situation classification unit 122 calculates the impurity (for example, entropy) of the reward (score) of each external factor, and extracts the high-order N external factors having high impurity.

The situation classification unit 122 extracts, for a predetermined M or more device control factor patterns (α, β, . . . , γ), the high-order N external factors having a large impurity in each device control factor pattern (α, β, . . . , γ). Then, the situation classification unit 122 refers to the upper N pieces of external factors of each extracted device control factor pattern, extracts P pieces of external factors in the descending order of the total number of appearance times of the external factors appearing in all the extracted device control factor patterns, and sets them as a component of “situation” (Situation).

The situation classification unit 122 divides the extracted P external factors into Q range widths for each external factor in the order of frequent occurrence to form a class, and constitutes a decision tree. Then, the situation classification unit 122 defines the final branch point in the constituted decision tree as one “situation” (Situation), that is, 1Situation. In the following description, in particular, when the “situation” of each of the branch (class) and the “situation” is intended, the “situation” (1Sitsuation) is described. The “situation” (1Situation) is equivalent to “the classification” of mention in a claim.

A situation classification unit 122 repeats extraction of an external factor having a large influence on a reward (score) and re-definition of “situation” (Situation), when learning data is insufficient, which is a period when variation of the external factor is small at the start of operation or the like, or at a predetermined time interval in an operation stage. When there is a change in the constituent element of the “situation” (Situation), the re-classification of the learning data and the re-generation of the learning model for each “situation” (1Situation) are performed by a learning data management unit 123 and a learning model management unit 124. After updating the learning model, for a “situation” (1Situation) in which the device control value predicted for the target reward (score) does not satisfy the target, the generation of the prediction control value and the update of the learning model are executed until the device control value satisfying the target reward (score) is found.

A learning data management unit 123 stores the device control value generated by the control value generation unit 121 and the score calculated by the score calculation unit 140 on the basis of the result of the device control as learning data in the learning data DB 400 for each “situation” (1Situation).

A learning model management unit 124 manages learning models 100 (100A, 100B, 100C, . . . ) for each “situation” (1Situation) which are reinforcement learned with learning data. The learning model management unit 124 re-generates a learning model for each “situation” (1Situation), when a component of “situation” (Situation) is changed in the situation classification unit 122,

Also, the learning model management unit 124, in generation of a learning model by reinforcement learning, even after ending a learning stage at the time when a predetermined target reward (score) is satisfied and shifting to an operation stage, acquires device control information (device control factor pattern) that summarizes for each “situation” (1Situation) the device control values of the controlled device 5 (excluding non-involved devices) and its score, and stores in the learning data DB 400.

A continuous disturbance determination unit 125 determines that continuous disturbance occurs and that the location characteristic is changed, when a period in which a predetermined target reward is not satisfied continues for a predetermined period T or longer in a device control factor pattern in the same “situation” (1Situation). Then, a continuous disturbance determination unit 125 deletes learning data of all “situation” (1Situation) at a corresponding location before the predetermined period T via a learning data management part 123, and causes the learning model to be updated.

After updating the learning model, for a “situation” (1Situation) that does not satisfy a target of a predicted device control value with respect to a target reward (score), causes the generation of the device control value and the update of the learning model until the device control value satisfying the target reward score is found.

A control value call unit 126 refers to the learning data DB 400 in the storage unit 12 on the basis of the “situation” (1Situation) determined by the situation recognition unit 110, in a learning stage and an operation stage, extracts a device control value (device control factor pattern) corresponding to the “situation” (1Situation), and outputs to a device control unit 130. At that time, a control value call unit 126 extracts a device control value having the highest reward (score) from the device control value included in the “situation” (1Situation) (device control factor pattern) and transmits to each control target device 5. Thus, for the learning model, the parameter can be adjusted so that the reward (score) becomes higher by reinforcement learning.

A control target device selection unit 127 specifies a device which is not involved in reward achievement in reinforcement learning when a learning stage is finished by reaching a predetermined reward (target reward), and specifies a range of “situation” (Situation) in which the specified device is not involved. Then, a control target device selection unit 127 selects a control target device 5 except for a device not involved in the specified “situation” (Situation) and executes device control as an operation stage.

The control target device selection unit 127 specifies a control target device again and updates the range of the “situation” (Situation) in which the device is non-involved, when in a operation stage, an external factor and a range defined as “situation” (Situation) are changed and when the location characteristic is changed or the like.

The control target device selection unit 127 includes non-involved device specification unit 1271 and a non-involved device update unit 1272.

A non-involved device specification unit 1271 specifies a device non-involved in the achievement of reward in the reinforcement learning (non-involved device) at the specific environment (location), and specifies a range of “situation” (Situation) in which the non-involved device is not involved. Specifically, the non-involved device specification unit 1271 has the following functions.

The non-involved device specification unit 1271 executes the following processing triggered by the completion of the learning stage of the learning model with the reinforcement learning by reaching a predetermined reward (target reward). the non-involved device specification unit 1271, when only a control value of a certain specific device X is changed for a device control factor pattern (device control value) for each “situation” (1Situation) stored in a learning data DB 400, determines whether or not the reward (score) is within a predetermined range. In order to avoid the “change” of value at this time from becoming a value close to the original control value, the control value after the change is generated by a random number, or the control value in a range not used in the range of the corresponding “situation” (1Situation). Then, the non-involved device specification part 1271 changes only the control value of the device X, acquires a reward (score) when each control target device 5 is controlled, and when the reward (score) falls within the same predetermined range as before the change, specifies the device X as a non-involved device candidate. Then, the non-involved device specification part 1271 performs similar processing to the device X in each “situation” (1Situation), and specifies the range of the non-involved “situation” (1Situation).

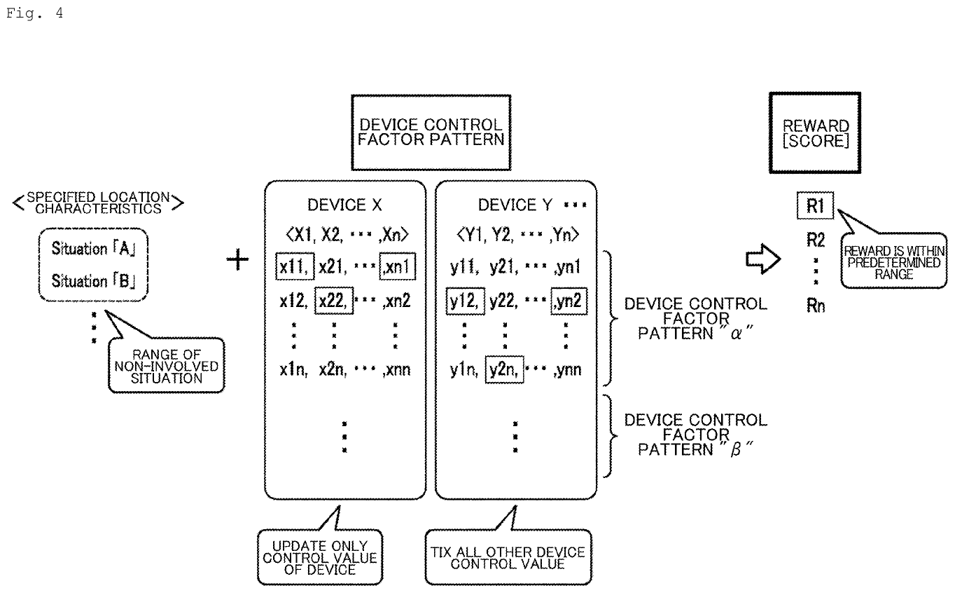

An description will now be given with reference to FIG. 4. A non-involved device specification unit 1271 extracts a device control factor pattern “a” in the same divided range in a certain “situation” (Situation “A”) and changes only the control value of the device X. Here, for the device Y, fix the values of the factors of the control values <Y1, Y2, . . . , Yn> to <y12, y2n, . . . , yn2>, for the device X, change the values of <x11, x22, . . . , xn1> among the factors of the control values <x1, x2, . . . , xn>. At this time, it is determined to which class (R1 to Rn) the value of the reward (score) belongs. For example, in the range of the reward R, in the case when the range of R1 is within a predetermined range (for example, a range equal to or larger than a target reward), when the value of the reward R in the case in which the value of the device X is changed falls in the class R1, the device X is determined as a non-involved device candidate because there is a possibility that the device is not involved in the achievement of the reward. This processing will be hereinafter referred to as “non-involved device candidate specification processing”.

In this processing, only the control value of the device X is changed for the device control factor patterns of all other “situation” (Situation) (Situation “B”, . . . ) so as to specify the range of “situation” (Situation) which is not involved. Here, for example, all the “situation” (Situation) may be specified as non-involved ranges, for example, only Situation “A” and Situation “B” may be specified as non-involved ranges.

Next, the non-involved device specification unit 1271 selects one device control value from device control factor patterns satisfying a predetermined reward (target reward) for each “situation” (1Situation) specified as non-involved, controls the control target device 5 excluding the non-involved device candidate device (here, the device X), and determines whether or not a predetermined reward (target reward) is satisfied continuously. When a predetermined reward (target reward) is satisfied as a result of the determination, the non-involved device specification unit 1271 determines the non-involved device candidate (device X) as a non-involved device, and the range of concerned “situation” (Situation) as the range of non-involved “situation” (Situation).

The non-involved device specification unit 1271 only selects one device control value from the device control factor patterns satisfying the prescribed reward (target reward), and determines whether or not the prescribed reward (target reward) is satisfied by excluding the non-involved device candidate, and it is not necessary to determine all the device control values. Since only one device control value satisfying a prescribed reward (target reward) is required to be known, there is a merit that the number of non-involved devices can be reduced even in a stage where the operation history is small.

The non-involved device specification unit 1271 similarly specifies a non-involved device candidate and a range of the “situation” (Situation) of the non-involved device candidate for another device (for example, a device Y). Then, the non-involved device specification unit 1271 controls the control target device 5 excluding the determined non-involved device (here, device X) and the non-involved device candidate (here, device Y), and continuously determines whether or not a predetermined reward (target reward) is satisfied. When a predetermined reward (target reward) is satisfied, in addition to the range of the device X and the “situation” (Situation) of non-involved, the device Y is determined as a non-involved device and the range of the “situation” (Situation) of non-involved is determined. This processing is repeated for all the control target device 5, and the range of the final non-involved device and the “situation” (Situation) of the non-involved device are determined.

The non-involved device specification unit 1271 outputs information on the range of the determined non-involved device and the “situation” (Situation) of the non-involved device to a learning data management unit 123, and thereby, in an operation stage, prevents a control value call unit 126 from extracting information on a device control value determined as a non-involved device in a range of a “situation” (Situation) of non-involved, when extracting a device control value (device control factor pattern) from the learning data DB 400. Therefore, the device control unit 130 transmits the device control value to each control target device 5 excluding the non-involved device in the range of the “situation” (Situation) of non-involved.

Thus, for the control target device 5 which is determined to be not involved in the reward (score) in the range of a specific “situation” (Situation), the power supply and control can be stopped or allocated to other tasks, and the device operation efficiency can be improved.

Returning to FIG. 3, the non-involved device update unit 1272, in an operation stage, upon a change in the data configuration of the learning data managed by the learning data management unit 123, updates information on a range of the non-involved device and the range of “situation” (Situation) of the non-involved device, which are specified by the non-involved device specification unit 1271.

Specifically, the non-involved device update unit 1272 detects the following three cases of the learning data, and updates the non-involved device and the range of the “situation” (Situation) of the non-involved device.

(Case 1) A Case in which the Range of the Branch (Class) of “Situation” (Situation) are Changed

The case is a case in which for each factor of an external factor <F1, F2, . . . , Fn>, the external factors being divided into Q range widths, are changed the external factors being divided into Q+1 range widths, or a case in which an upper limit value and a lower limit value of an external factor set in a certain external factor are changed.

The (Case 1) is triggered for example, when the situation classification unit 122 reviews classification of “situation” (Situation) at predetermined time intervals in an operation stage, and the re-classification of the learning data and the re-generation of the learning model are performed.

For example, in the target vehicle tracking system, if the external factor is the speed of the vehicle, and the previous external factor (component) was learned as 10-100 km/h, the new upper limit is 120 km/h, and the “Situation” (Situation) is redefined as 10-120 km/h time.

In the case of the (Case 1), when learning data of a newly defined “Situation” (Situation) is accumulated and a predetermined reward (target reward) are satisfied, the non-involved device update unit 1272 outputs an instruction information that causes the non-involved device specification unit 1271 to re-specify the non-involved device and the range of its non-involved “Situation” (Situation) (hereinafter referred to as the “non-involved device update instruction”).

(Case 2) A Case in which the Components of the External Factor are Changed

The case is a case in which the components of the external factor <F1, F2, . . . , Fn> themselves are changed, and defined as the “Situation” (Situation) configured with new external factor <F1′, F2′, . . . , Fn′>.

The (Case 2) is triggered for example, when as a result of review of the situation classification unit 122 of an external factor having a large influence on a reward (score) in the “situation” (Situation) at a predetermined time interval in an operation stage by a situation classification unit 122, the components of the external factor are changed, collection of learning data and regeneration of the learning model are performed until a predetermined reward (target reward) is satisfied.

For example, the case is triggered when wind speed is added as an external factor to the previously existing factors of vehicle speed, temperature, humidity, and illumination, and the divided range of the “situation” (Situation) is also re-defined as a new “situation” (Situation) including the range obtained by dividing the wind speed 0 m to 40 m.

In the case of (Case 2), the learning data management unit 123 discards the learning data up to that time. Then, when learning data of a newly defined “situation” (Situation) is accumulated in the learning data DB 400 and a predetermined reward (target reward) is satisfied, the non-involved device update unit 1272 outputs an instruction information (non-involved device update instruction) that causes the non-involved device specification unit 1271 to re-specify the non-involved device and the range of its non-involved “Situation” (Situation).

(Case 3) A Case in which the Location Characteristic Changes

The case is a case in which the continuous disturbance determination unit 125 determines that continuous disturbance occurs and the location characteristic is changed due to continuation of a period not satisfying a predetermined target reward for a predetermined period T or longer in an operation stage, the learning data of all “Situation” (1Situation) at the corresponding location before the predetermined period T are deleted via the learning data management unit 123, and the updating of the learning model is executed.

For example, the case is a case in which in an operation stage of the target vehicle tracking system, a “hump” (bump, knob) for reducing the speed of the traveling vehicle is installed on a road at a certain place on a course, and the photographing range on the course of an swing camera 5a which is the control target device 5 is limited cause of an building built by the course side. At this time, although the change of the environment cannot be measured by the information from the external factor, since the reward (score) continuously decreases, the continuous disturbance determination unit 125 determines that there is a change in the location characteristic.

In the (Case 3), the continuous disturbance determination unit 125 deletes the learning data of all “situation” (1Situation) at the corresponding location before the predetermined period T via the learning data management unit 123, and updates the learning model. Then, a continuous disturbance determination unit 125, after the learning model is updated, for target reward (score), in a “situation” (1Situation) which a predetermined target value of device control value is not satisfied, executes the generation of the device control value and the update of the learning model the device control value satisfying the target reward (score) is found.

When new learning data is stored in the learning data DB 400 and a predetermined reward (target reward) is satisfied, the non-involved device update unit 1272 outputs instruction information (non-involved device update instruction) for specifying a non-involved device and specifying a non-involved device and a non-involved “state” of the non-involved device again to the non-involved device specification unit 1271.

Thus, the non-involved device update unit 1272 can review the range of a device that is not involved in the reward (score) variation and the range of the “situation” (Situation) that is not involved, in response to environmental changes such as setting a new “situation” (Situation) in an operation stage, change in components of an external factor, changes in location characteristics. Thus, the device efficiency can be continuously improved after preventing the non-achievement of the prescribed reward due to the non-involved device to be originally involved due to the environmental change and the increase of the number of trials until the achievement of the prescribed reward.

Returning to FIG. 3, the device control unit 130 transmits the device control value determined by the reinforcement learning unit 120 to each of the control target devices 5 as control information. Thus, each control target device 5 executes control based on the device control value.

A score calculation unit 140 calculates a prescribed reward (score) on the basis of the control result of each control target device 5. The score calculation unit 140 acquires information necessary for calculating the reward (score) from each control target device 5, an external management device, or the like.

<Flow of Processing>

Next, a flow of the resource allocation processing performed by the control target device selection apparatus 1 will be described.

<<Non-Involved Device Specification Processing>>

First, a non-involved device specification processing executed by the control target device selection unit 127 of the control target device selection apparatus 1 (non-involved device specification unit 1271) will be described.

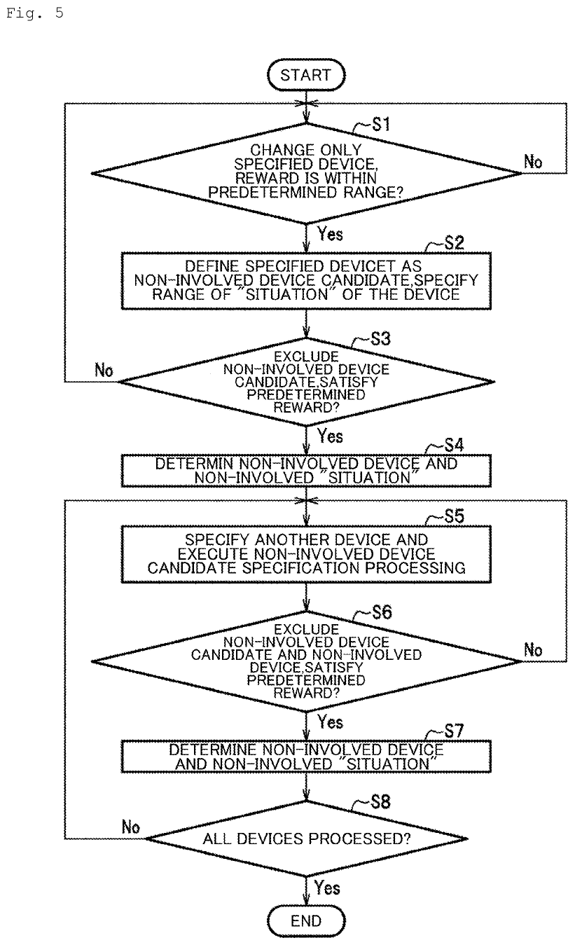

FIG. 5 is a flowchart showing the flow of non-involved device specification processing that is executed by the control target device selection apparatus 1 according to the present embodiment.

The non-involved device specification processing is executed when the learning stage is finished, that is, when the stage is shifted to the operation stage by reaching a prescribed reward (target reward). The control target device selection unit 127 (non-involved device specification unit 1271) can recognize the completion of the learning stage by receiving notification from the learning data management unit 123, or notification from a management device or the like of a system performing inter-device cooperation control.

First, a non-involved device specification unit 1271 of a control target device selection unit 127 specifies one control target device 5 (for example, device X), for a device control factor pattern (device control value) for each “situation” (1Situation) which is stored in the learning data DB 400, changes only the control value of the specified control target device 5 (device X), and it is determined whether or not a reward (score) falls within a predetermined range (step S1). Here, when the reward (score) is not settled within a predetermined range in all “situation” (1Situation) (step S1→No), and the specified control target device (device X) is determined to be a involved in reward achievement, and then in order to select the next control target device 5, the process returns to the step S1.

The non-involved device specification unit 1271 executes the determination of all the control target devices 5, and terminates the processing when it is determined that all the devices are devices involved in the reward achievement.

On the other hand, when the reward (score) is settled within the predetermined range in any “situation” (1Situation) (step S1→Yes), that is, that is, when even in one “situation” (1Situation) the reward (score) is settled within the predetermined range, the non-involved device specification unit 1271 determines the control target device 5 (device X) as a non-involved device candidate, and specifies the range of the “situation” (1Situation) of the non-involved device (step S2).

Note that, the processing the step S1 to S2 is referred to as “non-involved device candidate specification processing”.

Next, a non-involved device specification unit 1271 selects one device control factor pattern from device control factor patterns satisfying a predetermined reward (target reward) for each “situation” (1Situation) specified as non-involved, control each control target device 5 excluding the non-involved device candidate (here, device X), and continuously determines whether or not a prescribed reward (target reward) is satisfied (step S3).

Here, as a result of the determination, if the reward (score) does not satisfy a predetermined reward (target reward) for all of the specified “situation” (1Situation) (step S3→No), the specified non-involved device candidate (device X) is determined to be an involved device, the processing returns to the step S1 in order to select next control target device 5.

On the other hand, when the reward (score) satisfies a predetermined reward target reward in any “situation” (1Situation) (step S3→Yes), that is, when a predetermined reward (target reward) is satisfied even in one “situation” (1Situation), the non-involved device specification unit 1271 determines the non-involved device candidate (device X) as a non-involved device, and determines the “Situation” (1Situation) in which the prescribed reward (target reward) is satisfied as the range of non-involved “Situations” (1Situation) (step S4).

Next, the non-involved device specification unit 1271 specifies one of the other control target devices 5 that has not yet executed the non-involved device candidate specification processing (for example, device Y) is specified.

Then, similar to the step S1 to S2, the non-involved device candidate specification processing is executed (step S5). Thus, another control target device 5 (device Y) is specified as a non-involved device candidate, and the range of the non-involved “Situations” (1Situation) of the device is specified.

Subsequently, a non-involved device specification unit 1271 selects one device control value from device control factor patterns satisfying a predetermined reward (target reward) for each “situation” (1Situation) specified as non-involved in the step S5. Then, a non-involved device specification unit 1271 controls each control target device 5 excluding the non-involved device (device X) determined in the step S4 and the non-involved device candidate (device Y) specified in the step S5, continuously determines whether or not a prescribed reward (target reward) is satisfied (step S6).

Here, as a result of the determination, if the reward (score) does not satisfy a predetermined reward (target reward) for all of the specified “situation” (1Situation) (step S6→No), the specified non-involved device candidate (device Y) is determined to be a device involved in the achievement of the reward and the process returns to the step S5 in order to select the next control target device 5.

On the other hand, when the reward (score) satisfies a predetermined reward (target reward) in any “situation” (1Situation) (step S6→Yes), that is, when a predetermined reward (target reward) is satisfied even in one “situation” (1Situation), the non-involved device specification unit 1271 determines the non-involved device candidate (device Y) as a non-involved device, and determines the “Situation” (1Situation) in which the prescribed reward (target reward) is satisfied as the range of non-involved “Situations” (1Situation) (step S7).

Next, the non-involved device specification unit 1271 executes determining whether or not processing is performed for all the control target devices 5 (step S8), and when there is a control target device 5 not performing processing yet (step S8→No), The process returns to the step S5 and continues the processing.

On the other hand, when the processing is performed on all the control target devices 5 (step S8→YES), the non-related device specification unit 1271 terminates the processing.

<<Non-Involved Device Update Processing>>

Next, the process will be described in which, in an operation stage, the non-involved device update unit 1272 updates the information on non-involved devices and the range of “state” (Situation) of the non-involved devices specified by the non-involved device specification unit 1271, triggered by a change in the data configuration of the learning data managed by the learning data management unit 123.

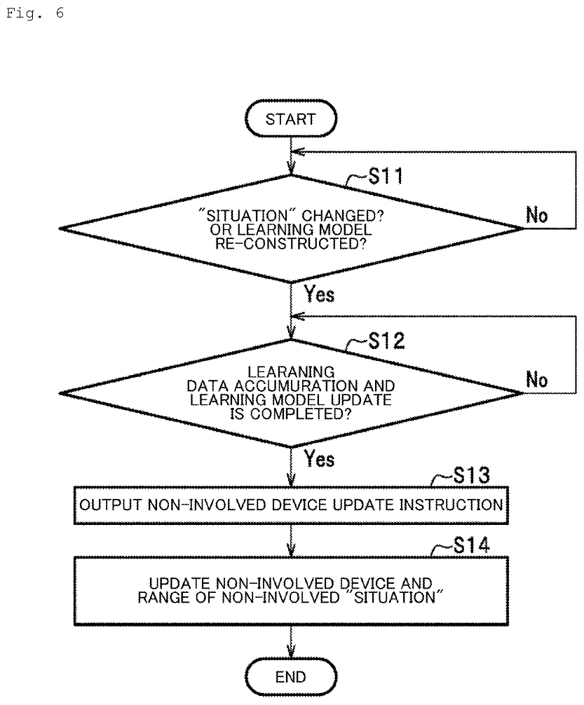

FIG. 6 is a flowchart illustrating a flow of non-involved device update processing performed by the control target device selection apparatus 1 according to the embodiment.

First, a non-involved device update unit 1272 determines whether the “Situation” (Situation) of the learning data has been changed or the learning model has been regenerated (reconstruction) due to updates to the external factors and ranges defined as the “Situation” (Situation) or changes in location characteristics during the operational phase (step S11).

Specifically, the non-involved device update unit 1272 determines whether there has been one of the above: (Case 1) a change in the range of the branch (classification) of the “Situation” (Situation), (Case 2) a change in the components of the external factors, or (Case 3) a change in location characteristics.

In the step S11, If none of the cases (Case 1) to (Case 3) apply (Step S11→No), the monitoring of whether or not the cases (Case 1) to (Case 3) have occurred in the operation phase is continued.

On the other hand, when the non-involved device update unit 1272 determines that the “Situation” (Situation) of the learning data has been changed or the learning model has been regenerated (reconstruction) due to the occurrence of any case of the cases (Case 1) to (Case 3) (Step S11→Yes), the process proceeds to step S12.

In a step S12, a non-involved device update unit 1272 stores determines whether accumulation of learning data satisfying a predetermined reward (target reward) as a result of correspondence of the control target device selection apparatus 1 to any of the (Case 1) to (Case 3), and update of the learning model is completed or not.

When the accumulation of the learning data and the update of the learning model are not completed, a non-involved device update unit 1272 waits until completion (step S12→No).

On the other hand, when it is determined that the accumulation of the learning data and the update of the learning model have been completed (step S12→Yes), the non-involved device update unit 1272 outputs a non-involved device update instruction of a retry instruction of non-involved device specification processing (refer to FIG. 5) to the non-involved device identification part 1271 (step S13).

The non-involved device specification unit 1271 executes non-involved device specification processing (FIG. 5), and updates the non-involved device and the range of “situation” (Situation) of the non-involved device, with the reception of the non-involved device update instruction as a trigger (step S14).

Thus, in response to an environmental change such as the definition of a new “situation” (Situation), change of components of “situation” (Situation), and change of a location characteristic, in an operation stage, the devices not involved in the reward variation and the range of “situation” (Situation) of the devices which is not involved in the reward variation can be reviewed.

<Hardware Configuration>

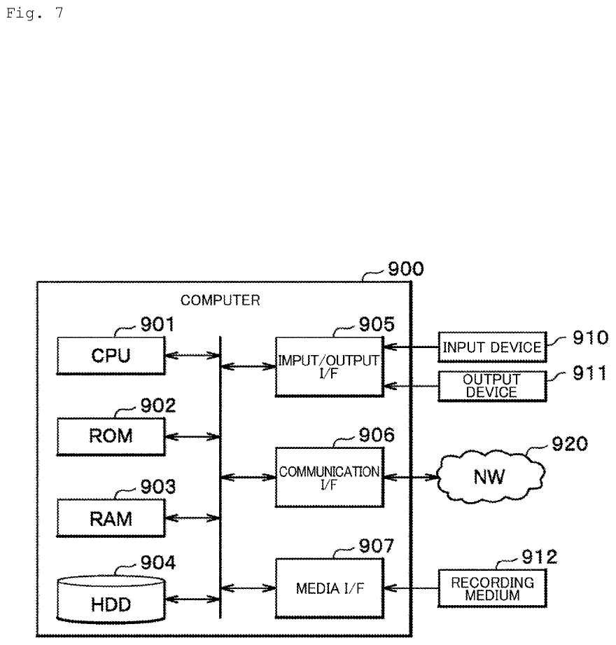

The control target device selection apparatus 1 according to the present embodiment is realized by, for example, a computer 900 having a configuration as shown in FIG. 7.

FIG. 7 is a hardware configuration diagram showing an example of the computer 900 that realizes the functions of the control target device selection apparatus 1 according to the present embodiment. The computer 900 includes a CPU 901, a ROM (Read Only Memory) 902, a RAM 903, an HDD (Hard Disk Drive) 904, an input/output I/F (Interface) 905, a communication I/F 906, and a media I/F 907.

The CPU 901 operates on the basis of a program stored in the ROM 902 or the HDD 904 and performs control by the control unit 10 of the control target device selection apparatus 1 shown in FIG. 3. The ROM 902 stores a boot program executed by the CPU 901 when the computer 900 is started, a program related to the hardware of the computer 900, and the like.

The CPU 901 controls an input apparatus 910 such as a mouse or a keyboard, and an output apparatus 911 such as a display or a printer, via the input/output I/F 905. The CPU 901 acquires data from the input device 910 and outputs generated data to the output device 911, via the input/output I/F 905. Note that a GPU (Graphics Processing Unit) or the like may be used together with the CPU 901 as processors.

The HDD 904 stores programs executed by the CPU 901, data used by the programs, and the like. The communication interface 906 receives data from other devices via a communication network (for example, NW (Network) 920), outputs the data to the CPU 901, and transmits data generated by the CPU 901 to other devices via the communication network.

The media interface 907 reads a program or data stored in a recording medium 912 and outputs the data to the CPU 901 via the RAM 903. The CPU 901 loads the program from the recording medium 912 on the RAM 903 via the media interface 907 and executes the loaded program. The recording medium 912 is an optical recording medium such as DVD (Digital Versatile Disc), PD (Phase change rewritable Disk), a magneto-optical recording medium such as MO (Magneto Optical disk), a magnetic recording medium, a conductor memory tape medium, a semiconductor memory, or the like.

For example, when the computer 900 serves as the control target device selection apparatus 1 according to the present embodiment, the CPU 901 of the computer 900 realizes the function of the control target device selection apparatus 1 by executing the program loaded on the RAM 903. Further, the data in the RAM 903 is stored in the HDD 904. The CPU 901 reads the program related to the target processing from the recording medium 912 and executes the program. In addition, the CPU 901 may read a program related to the target processing from another device via the communication network (NW920).

<Effects>

The effects of the control target device selection apparatus and the others according to the present invention will be described below.

A control target device selection device according to the present invention for selecting a control target device 5 includes:
a situation classification unit 122 which, with respect to external factors indicated by the data acquired from each IoT device 3, extracts an external factor that affects a reward as a component, by calculating an impurity of each external factor, divides the extracted value of the external factor into a predetermined range width, and defines a situation for controlling the control target device 5 as a classification for each divided range;
a control value generation unit 121 which, with respect to external factors indicated by the data acquired from each IoT device 3, generates a device control value of a plurality of control target device 5 for each of the classification;
a score calculation unit 140 which calculates a score indicating a reward obtained from a control result of each of the control target device 5;
a learning data management unit 123 which stores in a learning data DB 400, each learning data indicated by the device control value and the score, for each device control factor pattern indicating a device control value included in the same classification;
a learning model management unit 124 which generates a learning model for each of the classifications by performing reinforcement learning so as to satisfy a predetermined reward by using the learning data;
a non-involved device specification unit 1271 which, with respect to the device control factor pattern of each of the classifications,
changes only a control value of a specific control target device 5,
when a score that is a control result after change, falls within a predetermined range among ranges obtained by dividing an upper limit value and a lower limit value of the score into predetermined range widths,
executes a non-involved device candidate specification processing for specifying the specific control target device 5 as a non-involved device candidate and specifying a range of non-involved classification in the non-involved device candidate,
executes the non-involved device candidate specification processing in each of the control target devices 5,
selects a device control value from the device control factor patterns for each non-involved classification,
executes control of the control target device 5 excluding the specified non-involved device candidate,
and when a prescribed reward is satisfied, determines the non-involved device candidate as a non-involved device and the range of the non-involved classification;
and a device control unit 130 which, with respect to the range of the non-involved classification, transmits the device control value to each control target device 5 excluding the non-involved device.

Thus, the control target device selection apparatus 1 to be controlled specifies a range of (class of) a “situation” (Situation)” range in which the device is not involved in the achievement of the reward in the reinforcement learning, selects a device to be controlled other than the device not involved, and can improve device operation efficiency.

The control target device selection apparatus 1 further includes:
a continuous disturbance determination unit 125 which determines that a location characteristic indicating a factor affecting the unknown or unmeasured reward other than the external factor has changed when a score of the learning data in the same classification does not satisfy the predetermined reward continuously for a predetermined period or longer; and a non-involved device update unit 1272;
wherein, when the non-involved device update unit 1272 detecting any one of following cases:
   a case in which the learning data management unit 123 deletes learning data before the predetermined period of time when the continuous disturbance determination unit 125 determines that the score does not satisfy the predetermined reward continuously for the predetermined period of time or longer and the location characteristic has changed, and the learning model management unit 124 updates the learning model for each classification;
   a case in which the learning data management unit 123 re-classifies the learning data when a range in the definition of the classification is changed as a result of the definition of the classification being performed again by the situation classification unit 122 at a predetermined time interval, and the learning model management unit 124 updates the learning data in the classification after the change;
   a case in which the learning data management unit 123 deletes previous learning data when the condition classification unit 122 extracts components of the external factor affecting the reward at predetermined time intervals and the components change, and the learning model management unit 124 updates the learning model for each classification using the changed component;
outputs a non-involved device update instruction for re-executing the determination of the non-involved device and the determination of the range of the non-involved classification to the non-involved device specification unit 1271.

Thus, the control target device selection apparatus 1 in accordance with a change in environment change (a change in location characteristics, a change in a range of classification, and a change in a component) in an operation stage, can review the non-involved device and the range of non-involved classification of the device. Thus, non-achievement of the prescribed reward due to non-involved of the control target device 5 which should be originally involved due to environmental change and increase of the number of trial times of learning data generation until the prescribed reward is achieved are prevented, and device operation efficiency can be continuously improved.

Note that the present invention is not limited to the embodiment described above, and various modifications can be made by a person of ordinary skill in the art within the technical idea of the present invention.

### REFERENCE SIGNS LIST

1 Control target device
3 IoT device management apparatus
5 Control device
10 Control unit
11 Input/output unit
12 Storage unit
100 Learning model
110 Situation recognition unit
120 Reinforcement learning unit
121 Control value generation unit
122 Situation classification unit
123 Learning data management unit
124 Learning model management unit
125 Continuous disturbance determination unit
126 Control value call unit
127 Control target device selection unit
130 Device control unit
140 Score calculation unit
200 IoT device information DB
300 Control target device information DB
400 Learning data DB
1271 Non-involved device specification unit
1272 Non-involved device update unit

1. A control target device selection apparatus for selecting a control target device comprising:
a situation classification unit configured to, with respect to external factors indicated by the data acquired from each IoT device, extract an external factor that affects a reward as a component, by calculating an impurity of each external factor, divide the extracted value of the external factor into a predetermined range width, and define a situation for controlling the control target device as a classification for each divided range;
a control value generation unit configured to, with respect to external factors indicated by the data acquired from each IoT device, generate a device control value of a plurality of control target device for each of the classification;
a score calculation unit configured to calculate a score indicating a reward obtained from a control result of each of the control target device;
a learning data management unit configured to store in a learning data DB, each learning data indicated by the device control value and the score, for each device control factor pattern indicating a device control value included in the same classification;
a learning model management unit configured to generate a learning model for each of the classifications by performing reinforcement learning so as to satisfy a predetermined reward by using the learning data;
a non-involved device specification unit configured to, with respect to the device control factor pattern of each of the classifications, change only a control value of a specific control target device, when a score that is a control result after change, the non-involved device specification unit is configured to fall within a predetermined range among ranges obtained by dividing an upper limit value and a lower limit value of the score into predetermined range widths, execute a non-involved device candidate specification processing for specifying the specific control target device as a non-involved device candidate and specifying a range of non-involved classification in the non-involved device candidate, execute the non-involved device candidate specification processing in each of the control target devices, select a device control value from the device control factor patterns for each non-involved classification, execute control of the control target device excluding the specified non-involved device candidate, and when a prescribed reward is satisfied, the non-involved device specification unit is configured to determine the non-involved device candidate as a non-involved device and the range of the non-involved classification; and
a device control unit configured to, with respect to the range of the non-involved classification, transmit the device control value to each control target device excluding the non-involved device.

2. The control target device selection apparatus according to claim 1 further comprising:
a continuous disturbance determination unit configured to determine that a location characteristic indicating a factor affecting the unknown or unmeasured reward other than the external factor has changed when a score of the learning data in the same classification does not satisfy the predetermined reward continuously for a predetermined period; and
a non-involved device update unit;
wherein, when the non-involved device update unit detects any one of following conditions:
(i) the learning data management unit deletes learning data before the predetermined period of time when the continuous disturbance determination unit determines that the score does not satisfy the predetermined reward continuously for the predetermined period of time or longer and the location characteristic has changed, and the learning model management unit updates the learning model for each classification;
(ii) in which the learning data management unit re-classifies the learning data when a range in the definition of the classification is changed as a result of the definition of the classification being performed again by the situation classification unit at a predetermined time interval, and the learning model management unit updates the learning data in the classification after the change;
(iii) in which the learning data management unit deletes previous learning data when the condition classification unit extracts components of the external factor affecting the reward at predetermined time intervals and the components change, and the learning model management unit updates the learning model for each classification using the changed component;
the non-involved device update unit is configured to output a non-involved device update instruction for re-executing the determination of the non-involved device and the determination of the range of the non-involved classification to the non-involved device specification unit.

3. A control target device selection method for selecting a control target device comprising:
with respect to external factors indicated by the data acquired from each IoT device, extracting an external factor that affects a reward as a component, by calculating an impurity of each external factor, dividing the extracted value of the external factor into a predetermined range width, and defining a situation for controlling the control target device as a classification for each divided range;
with respect to external factors indicated by the data acquired from each IoT device, generating a device control value of a plurality of control target device for each of the classification;
calculating a score indicating a reward obtained from a control result of each of the control target device;
calculating stores in a learning data DB, each learning data indicated by the device control value and the score, for each device control factor pattern indicating a device control value included in the same classification;
generating a learning model for each of the classifications by performing reinforcement learning so as to satisfy a predetermined reward by using the learning data;
with respect to the device control factor pattern of each of the classifications changing only a control value of a specific control target device,
when a score that is a control result after change, falling within a predetermined range among ranges obtained by dividing an upper limit value and a lower limit value of the score into predetermined range widths, executing a non-involved device candidate specification processing for specifying the specific control target device as a non-involved device candidate and specifying a range of non-involved classification in the non-involved device candidate,
executing the non-involved device candidate specification processing in each of the control target devices, selecting a device control value from the device control factor patterns for each non-involved classification, executing control of the control target device excluding the specified non-involved device candidate, and when a prescribed reward is satisfied, determining the non-involved device candidate as a non-involved device and the range of the non-involved classification; and
with respect to the range of the non-involved classification, transmitting the device control value to each control target device excluding the non-involved device.

4. A non-transitory computer readable medium storing a program, wherein executing of the program causes a computer to operate as the control target device selection apparatus according to claim 1.

5. A non-transitory computer readable medium storing a program, wherein executing of the program causes a computer to operate as the control target device selection apparatus according to claim 2.
